(19) United States
(12) Patent Application Publication
(10) Pub. No.: US 2008/0030458 A1
(43) Pub. Date: Feb. 7, 2008

(54) Inertial input apparatus and method with optical motion state detection

(76) Inventors: Rene Helbing, Palo Alto, CA (US); Annette C. Grot, San Jose, CA (US)

Correspondence Address: Kathy Manke;Avago Technologies Limited, 4380 Ziegler Road, Fort Collins, CO, 80525, US

(21) Appl. No.: 11/500,149

(22) Filed: Aug. 7, 2006

(51) Int. Cl. G09G 5/00

(52) U.S. Cl. 345/156

(57) ABSTRACT

An apparatus includes an inertia sensing system, an optical motion sensing system, and a processing system. The inertia sensing system generates inertial data indicative of movement in relation to an inertial reference frame. The optical motion sensing system generates optical data from received light. The processing system determines movement measures from the inertial data. The processing system also select one of an in-motion output state and a motionless output state based on the optical data. During the in-motion output state, the processing system produces an output corresponding to the movement measures. During the motionless output state, the processing system produces an output indicative of zero motion regardless of the inertial data.

### BACKGROUND

Many different types of devices have been developed for inputting commands into a machine. For example, hand-manipulated input devices, such as computer mice, joysticks, trackballs, touchpads, and keyboards, commonly are used to input instructions into a computer by manipulating the input device. Such input devices allow a user to control movement of a virtual pointer, such as a cursor, across a computer screen, select or move an icon or other virtual object displayed on the computer screen, and open and close menu items corresponding to different input commands. Input devices commonly are used in both desktop computer systems and portable computing systems.

Input devices typically include a mechanism for converting a user input into user interface control signals, such as cursor position data and scrolling position and distance data. Although some types of input device use electromechanical transducers to convert user manipulation of the input device into user interface control signals, most recently developed input devices use optical navigation sensors to convert user manipulation of the input device into user interface control signals. The optical navigation sensors employ optical navigation technology that measures changes in position by acquiring a sequence of images of light reflecting from a surface and mathematically determining the direction and magnitude of movement over the surface from comparisons of corresponding features in the images. Such optical navigation systems typically track the scanned path of the input device based on detected pixel-to-pixel surface reflectivity differences that are captured in the images. These changes in reflectivity may be quite small depending upon the surface medium (e.g., on the order of 6% for white paper).

One problem with existing optical navigation sensors is that they are unable to navigate well on very smooth surfaces, such as glass, because the images reflected from such surfaces are insufficiently different to enable the direction and magnitude of movement over the surface to be determined reliably. In an attempt to solve this problem, optical navigation sensors have been proposed that illuminate smooth-surfaced objects with coherent light. The objects induce phase patterns in the illuminating light that are correlated with optical nonuniformities in or on the objects. Optical navigation sensors of this type include an interferometer that converts the phase patterns into interference patterns (or interferograms) that are used to determine relative movement with respect to the objects. Although this approach improves navigation performance over specular surfaces, uniform surfaces, and surfaces with shallow features, this approach relies on optical nonuniformities, such as scratches, imperfections, and particulate matter in or on the surface to produce the phase patterns that are converted into the interferograms by the component interferometers. As a result, this approach is unable to navigate reliably over surfaces that are free of such specular features.

What are needed are systems and methods that are capable of accurately generating control signals in response to movements over all types of surfaces, including smooth surfaces and surfaces that are substantially transparent to illuminating light.

### SUMMARY

In one aspect, the invention features an apparatus that includes an inertia sensing system, an optical motion sensing system, and a processing system. The inertia sensing system generates inertial data indicative of movement in relation to an inertial reference frame. The optical motion sensing system generates optical data from received light. The processing system determines movement measures from the inertial data. The processing system also selects one of an in-motion output state and a motionless output state based on the optical data. During the in-motion output state, the processing system produces an output corresponding to the movement measures. During the motionless output state, the processing system produces an output indicative of zero motion regardless of the inertial data.

In another aspect, the invention features a method in accordance with which inertial data indicative of movement in relation to an inertial reference frame is generated. Optical data is generated from received light. Movement measures are determined from the inertial data. One of an in-motion output state and a motionless output state is selected based on the optical data. During the in-motion output state, an output corresponding to the movement measures is produced. During the motionless output state, an output indicative of zero motion is produced regardless of the inertial data.

Other features and advantages of the invention will become apparent from the following description, including the drawings and the claims.

### DESCRIPTION OF DRAWINGS

FIG. 1 is a block diagram of an embodiment of an input apparatus in an exemplary operational environment.

FIG. 2 is a flow diagram of an embodiment of a method implemented by an embodiment of the input apparatus shown in FIG. 1.

FIG. 3 is a diagrammatic view of an embodiment of the input apparatus shown in FIG. 1.

FIG. 4 is a diagrammatic view of an embodiment of the input apparatus shown in FIG. 1.

FIG. 5 is a diagrammatic view of an embodiment of the input apparatus shown in FIG. 1.

FIG. 6 is a block diagram of an embodiment of an optical motion sensing system.

FIG. 7 is a block diagram of an embodiment of an optical motion sensing system.

FIG. 8 is a diagrammatic view of a light sensor superimposed on an image of a speckle pattern.

FIG. 9 is a devised graph of light intensity determined from light measured by the light sensor shown in FIG. 7 plotted as a function of time.

FIG. 10 is a block diagram of an embodiment of an optical lift detection system.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. Introduction

The embodiments that are described in detail below provide input apparatus that are capable of generating control signals (e.g., user interface control signals) in response to movements in relation to a fixed inertial reference frame (e.g., a reference frame defined by the direction of gravitational acceleration). These embodiments include an inertial sensing system that generates inertial data from which movement measures (e.g., measures of displacement, velocity, or acceleration) are determined. The movement measures are translated into control signals. Because the movement measures are determined based on changes in relation to a fixed inertial reference frame, these embodiments are capable of generating control signals independently of the surfaces over which the input apparatus might be moved. In this way, these embodiments avoid the limitations of optical navigation sensors with respect to navigating over smooth surfaces and surfaces that are substantially transparent to the illuminating light.

In addition, these embodiments overcome problems that typically result from the noise that is inherent in inertia-based navigation systems. In particular, these embodiments include an optical motion sensing system that generates optical data from which it may be determined whether the apparatus is in-motion or is motionless, independently of the inherently noisy inertial data that is generated by the inertial sensing system. If the apparatus is determined to be in-motion, the control signals are produced from the movement measures. If the apparatus is determined to be motionless, the control signals are set to reflect zero motion of the apparatus regardless of the inertial data. In this way, these embodiments avoid the problems associated with the accumulation of residual noise bias, which otherwise might cause these embodiments to generate erroneous control signals indicative of movement during periods when the input apparatus (or a movable input part of the input apparatus) is in fact motionless.

### II. Overview

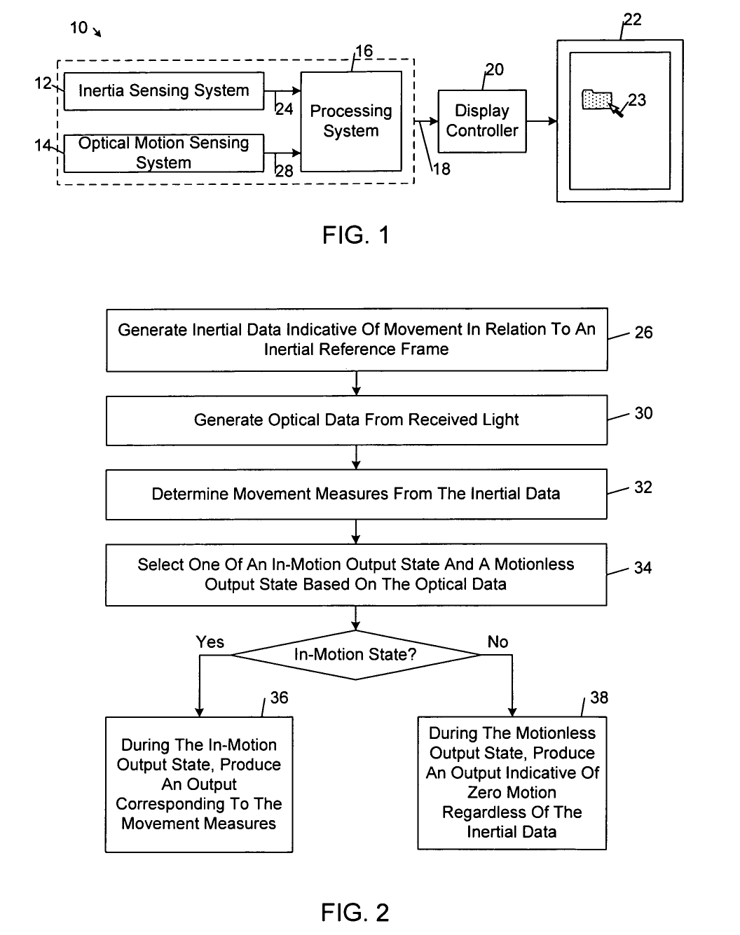

FIG. 1 shows an embodiment of an input apparatus 10 that includes an inertia sensing system 12, an optical motion sensing system 14, and a processing system 16.

In general, the input apparatus 10 may be incorporated into any type of device or system in which sensing relative motion serves a useful purpose. For illustrative purposes, the input apparatus 10 is described herein as a component of a device for inputting commands into a machine, where the input apparatus 10 may have any of a wide variety of different form factors, including a computer mouse, a joystick, a trackball, and a steering wheel controller. In these implementations, the input apparatus 10 may be configured to sense user manipulations of a component of the input device (e.g., a touch pad, a trackball, or a joystick) or manipulations of the input device itself (e.g., movement of the input device across a surface or through the air).

In general, the processing system 18 may be implemented by one or more discrete modules that are not limited to any particular hardware, firmware, or software configuration. The one or more modules may be implemented in any computing or data processing environment, including in digital electronic circuitry (e.g., an application-specific integrated circuit, such as a digital signal processor (DSP)) or in computer hardware, firmware, device driver, or software.

In the illustrative operational environment shown in FIG. 1, the input apparatus 10 outputs display control signals 18 to a display controller 20 that drives a display 22. The display controller 20 processes the display control signals 18 to control, for example, the movement of a pointer 23 on the display 22. The display controller 20 typically executes a driver to process the display control signals 18. In general, the driver may be implemented in any computing or processing environment, including in digital electronic circuitry or in computer hardware, firmware, or software. In some embodiments, the driver is a component of an operating system or a software application program. The display 22 may be, for example, a flat panel display, such as a LCD (liquid crystal display), a plasma display, an EL display (electro-luminescent display) and a FED (field emission display).

In some embodiments, the input apparatus 10 and the display 22 are implemented as separate discrete devices, such as a separate pointing device and a remote display-based system. In these embodiments, the remote system may be any type of display-based appliance that receives user input, including a general-purpose computer system, a special-purpose computer system, and a video game system. The display control signals 18 may be transmitted to the remote system over a wired communication link (e.g., a serial communication link, such as an RS-232 serial port, a universal serial bus, or a PS/2 port) or a wireless communication link (e.g., , an infrared (IR) wireless link or a radio frequency (RF) wireless link). In other embodiments, the input apparatus 10 and the display 22 are integrated into a single unitary device, such as a portable (e.g., handheld) electronic device. The portable electronic device may be any type of device that can be readily carried by a person, including a cellular telephone, a cordless telephone, a pager, a personal digital assistant (PDA), a digital audio player, a digital camera, and a digital video game console.

FIG. 2 shows a flow diagram of an embodiment of a method that is implemented by the input apparatus 10 that is shown in FIG. 1.

In accordance with this method, the inertia sensing system 12 generates inertial data 24 indicative of movement in relation to an inertial reference frame (FIG. 2, block 26). In most situations, the inertial reference frame is defined by the direction of gravitational acceleration. The inertial sensor 16 may include any type of inertia sensing device, including accelerometers and angular rate sensors. Accelerometers sense and respond to translational accelerations, whereas angular rate sensors sense and respond to rotational accelerations.

The optical motion sensing system 14 generates optical data 28 from received light (FIG. 2, block 30). In some embodiments, the optical data 28 corresponds to a sequence of images captured by one-dimensional or two-dimensional arrays of photosensors over time. In other embodiments, the optical data 28 corresponds to a sequence of intensity values representative of the aggregate intensity of light received over an active light sensing area. In some embodiments, the optical data 28 is generated from light that is reflected by a surface adjacent to the input apparatus 10. In other embodiments, the optical data 28 is generated from light that is received from one or more locations that are remote from the input apparatus.

The processing system 16 determines movement measures from the inertial data 24 (FIG. 2, block 32). The movement measures typically correspond to one or more of displacement parameter values, velocity parameter values, and acceleration parameter values. As mentioned above, inertial sensors, such as accelerometers and angular rate sensors, produce outputs that measure acceleration. Accordingly, the processing system 16 may determine velocity parameter values by single integration of the outputs of these types of inertial sensors and may determine displacement parameter values by double integration of such outputs. The resulting movement measures describe movements of the input apparatus (or a movable input part of the input apparatus) relative to the inertial reference frame. As explained in detail below, in some embodiments, the processing system 16 determines the movement measures in ways that compensate for accelerations due to at least one of static tilt and dynamic tilt in relation to the inertial reference frame.

The processing system 16 selects one of an in-motion output state and a motionless output state based on the optical data 28 (FIG. 2, block 34). The in-motion output state is a state in which the input apparatus (or a movable input part of the input apparatus) is determined to be moving, whereas the motionless output state is a state in which the input apparatus (or a movable input part of the input apparatus) is determined to be motionless. In general, the processing system 16 makes the selection between the in-motion output state and the motionless output state based on changes in the optical data 28 over time that satisfy one or more specified optical motion predicates. In some embodiments, the processing system 16 makes the selection based on the detection of movement of corresponding features in successive images that are captured by the optical motion sensing system 14. In other embodiments, the processing system 16 makes the selection based on the detection of aggregate intensities that exceed a moving average aggregate intensity by a specified threshold value.

During the in-motion output state, the processing system 16 produces an output corresponding to the movement measures (FIG. 2, block 36). For example, in some embodiments, the processing system 16 generates the control signals 18 from the movement measures. In some of these embodiments, the display control signals 18 correspond exactly to the movement measures. In other ones of these embodiments, the display control signals 18 are derived (or translated) from the movement measures. Examples of the types of display control signals 20 that may be produced by the processing system 18 include: position data (e.g., distance and direction in a coordinate system centered at the origin of the operational zone) that describe the relative position of the input apparatus (or a movable part of the input apparatus); cursor position and velocity data; and scrolling position and distance data.

During the motionless output state, the processing system 16 produces an output indicative of zero motion regardless of the inertial data (FIG. 2, block 38). In this process, the processing system 16 sets the control signals 18 to reflect zero motion of the input apparatus (or a movable input part of the input apparatus) regardless of any movement that might be indicated by the inertial data 24. In this way, the processing system 16 avoids generating erroneous control signals during motionless periods from the noise inherent in the outputs of most inertial sensors.

### III. Exemplary Embodiments of the Input Apparatus Architecture

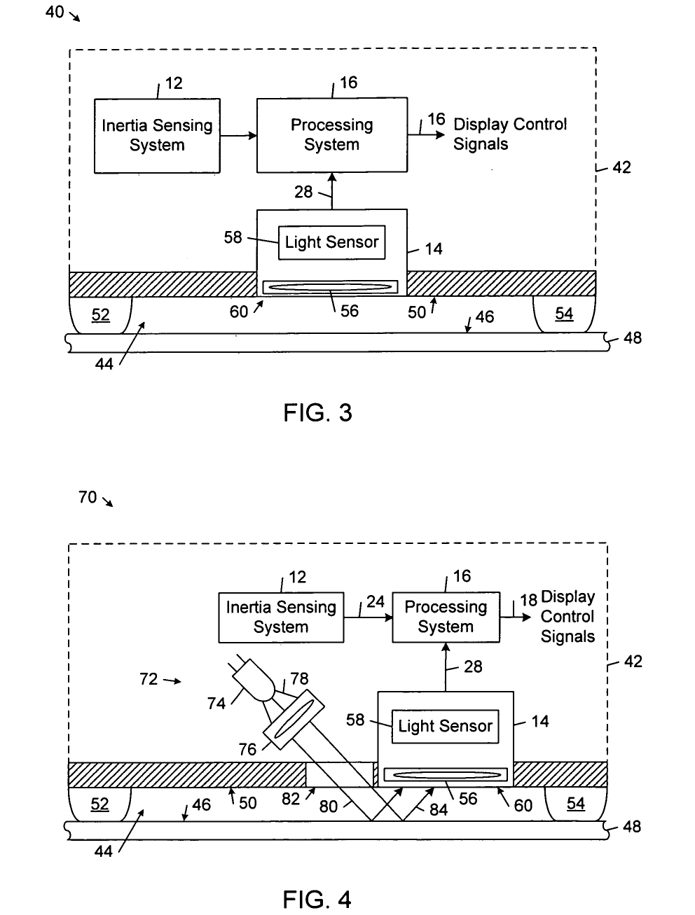

FIG. 3 shows an embodiment 40 of the input apparatus 10 that includes a housing 42 that contains the inertial sensing system 12, the optical motion sensing system 14, and the processing system 16. The housing 42 additionally includes a bottom side 44 that is configured to slide over a surface 46 of an object 48 (e.g., a tabletop). In this regard, the housing 42 includes a bottom surface 50 that supports a set of sliders 52, 54, which have low friction surfaces that facilitate sliding over the object surface 46. In this embodiment, the optical motion sensing system 14 includes an optical focusing system 56 that includes one or more optical elements (e.g., refractive lenses, diffractive lenses, and optical filters). The optical focusing system 56 focuses light from a relatively short distance (e.g., 0.1 millimeter to 10 millimeters) away from the bottom surface 50 of the housing 42 onto an active area (or capture plane) of a light sensor 58. The heights of the sliders 52, 54 typically are set so that the front focal plane of the optical focusing system 56 coincides with the object surface 46 when the input apparatus 40 is placed against the object surface 46. The optical focusing system 56 receives light through an optical port 60 in the bottom surface 50 of the housing 42.

FIG. 4 shows an embodiment 70 of the input apparatus 10 that corresponds to the input apparatus 40 (shown in FIG. 3), except that the input apparatus 70 additionally includes an illumination system 72. In the illustrated embodiment, the illumination system 72 is implemented by a light source 74 (e.g., a light emitting diode or a laser) and an optical element 76 that collimates the light 78 that is produced by the light source 72 into a collimated output light beam 80, which exits the housing 42 through an optical port 82 that is defined in the bottom surface 50 of the housing 42. The illumination system 72 is oriented to direct the output light beam 80 toward the object 48 to produce the reflected beam 84 when the bottom side 44 of the housing 42 is adjacent the surface 46 of the object 48.

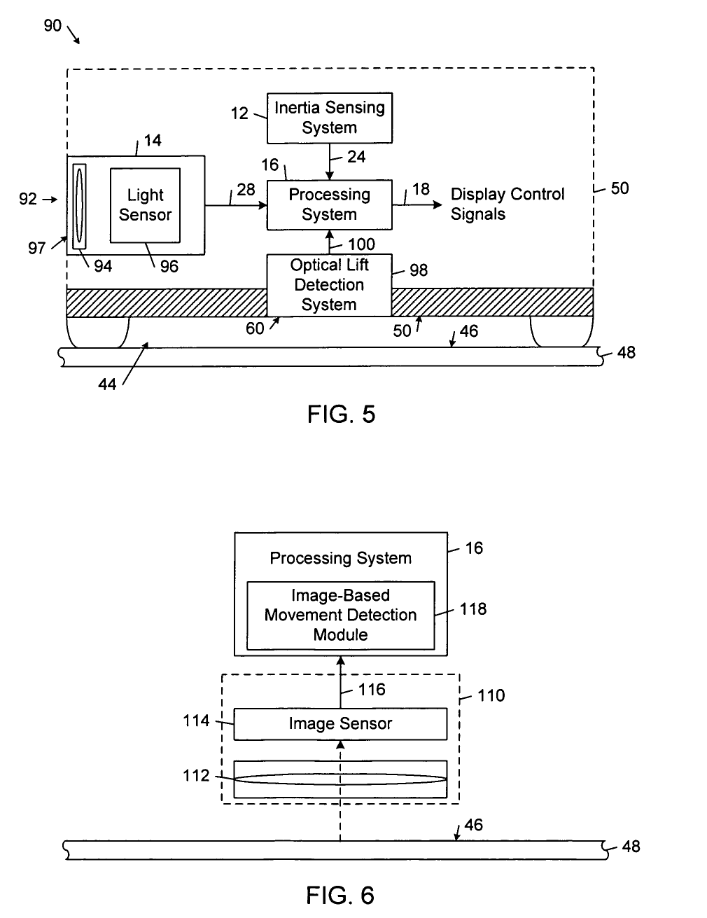

FIG. 5 shows an embodiment 90 of the input apparatus 10 that corresponds to the input apparatus 40 (shown in FIG. 3), except that in the input apparatus 90 the optical motion sensing system 14 generates the optical data 28 in response to light received from an optical input side 92 of the housing 42 that is different from the bottom side 44. The optical input side 92 may correspond to any side of the housing 42 other than the bottom side 44, including any of the front, back, left, right, and top sides of the housing 42. In this embodiment, the optical motion sensing system 14 includes an optical focusing system 94 one or more optical elements (e.g., refractive lenses, diffractive lenses, and optical filters). The optical focusing system 94 has a front focal plane located a relatively long distance (e.g., 1 meter to infinity) away from the input apparatus 90 and a back focal plane that coincides with an active area (or capture plane) of a light sensor 96. The optical focusing system 94 receives light through an optical port 97 in the optical input side 92 of the housing 42.

The input apparatus 90 additionally includes an optical lift detector 98 that is configured to generate a lift detection output 100 that indicates whether or not the bottom side 44 of the housing 42 is adjacent to the object surface 46. In this embodiment, the processing system 16 sets the input apparatus 10 into the motionless output state in response to a determination that the lift detection output 100 indicates that the bottom side 44 of the housing 42 is not adjacent to the object surface 46, regardless of the inertial data 24 and the optical data 28.

### IV. Exemplary Embodiments of Components of the Input Apparatus

A. Exemplary Inertia Sensing System Embodiments

The inertia sensing system 14 generates data that is indicative of movement of the housing 12 relative to an inertial reference frame. As explained above, in most situations, the inertial reference frame is defined by the direction of gravitational acceleration. The inertial sensor 16 may include any type of inertia sensing device, including accelerometers and angular rate sensors.

In some implementations, the inertia sensing system 14 includes at least two inertia sensing devices that are configured to sense motions in at least two respective directions.

For example, in one implementation, the inertia sensing system 14 includes two inertia sensing devices that are oriented in orthogonal directions in a plane (e.g., an X-Y plane in a two-dimensional Cartesian coordinate system). The first and second inertial sensors typically are identical. In these embodiments, the inertial data that is generated by the first and second inertial sensors are combined to determine the motion and orientation of the input apparatus 10 relative to the inertial reference frame over time. The orientation (i.e., tilt, pitch, and yaw) of the input device 10 may be computed by correlating the axes measured by inertial sensors to the orientation of the input apparatus 10.

In another implementation, the inertia sensing system 14 includes three inertia sensing devices that are oriented in three noncollinear directions (e.g., X, Y, and Z directions in a three-dimensional Cartesian coordinate system). This implementation enables the motion of the input apparatus 10 to be tracked independently of the orientation of the object surface over which the input apparatus may be moved.

In some embodiments, the inertial sensing system 12 includes at least one accelerometer that produces a respective accelerator output, and the processing system 16 is operable to determine at least some of the motion measures from the accelerator output. In this process, the processing system 16 determines from the accelerator output measures of static tilt in relation to the inertial reference frame, and the processing system is operable to determine at least some of the motion measures from the accelerometer output and the measures of static tilt. In some implementations, a zero g offset (i.e., the deviation of the accelerometer output value from the ideal output value when there is no acceleration present) is subtracted from the accelerometer output and the resulting difference value is used as an index into a lookup table that maps differences from the zero g offset to predetermined degrees of tilt. In other implementations, the degree of tilt θ is determined directly from the accelerometer output V_{OUT} (in volts) using equation (1):

$$θ = arcsin ( \frac{{V}_{OUT} - {V}_{OFFSET}}{ζ} ) \qquad ( 1 )$$

wherein V_{OFFSET} is the zero g offset voltage for the accelerometer and ζ is the sensitivity of the accelerometer. In these embodiments, during the motionless output states, the processing system 16 determines the degree of tilt and stores the current tilt value (θ_{STOR}) in memory. During the in-motion output states, the processing system 16 uses the one or more stored measures of the current degree of tilt to compensate for static tilt in the determination of the movement measures. In this process, the processing system 16 determines the current compensated accelerometer output (V_{COMP}(t)) from the current measured accelerometer output (V_{MEAS}(t)) and the stored tilt value (θ_{STOR}) using equation (2):

V_{COMP}(t)=V_{MEAS}(t)−[ζ×g×sin(θ_{STOR})] (2)

where g=9.8 meters per second.

In some embodiments, the inertial sensing system 12 includes at least one angular rate sensor (e.g., a gyroscope) that produces a respective angular rate sensor output, and the processing system is operable to determine measures of dynamic tilt from the angular rate sensor output and to determine at least some of the motion measures from the accelerometer output and the measures of dynamic tilt. In these embodiments, each accelerometer is paired with a corresponding angular rate sensor, where the sensitivity axes of the accelerometer and the angular rate sensor in each pair are aligned. The angular rate sensors measure the rate that the input apparatus (or a movable input part of the input apparatus) rotates about each axis. For example, in some implementations, the inertial sensors are located along an axis that is parallel to and overlies the center of gravity of the input apparatus 10. In these implementations, the rate of change of the yaw rate (\ddot{θ}) is given by equation (3):

$$\ddot{θ} = \frac{{a}_{1} - {a}_{2}}{{d}_{1} + {d}_{2}} \qquad ( 3 )$$

where a₁ and a₂ are the accelerations measured by the inertial sensors respectively, and d₁ and d₂ are the respective distances between the inertial sensors and the center of gravity of the input apparatus 10.

The processing system 16 integrates the angular rate sensor outputs over time to obtain measures of the rotational angle as a function of time for each of the coordinate axes. The processing system 16 integrates the rotational angle information over time to determine the pitch and roll of the input apparatus (or a movable input part of the input apparatus) as a function of time. Based on the calculated pitch and roll information, the processing system 16 subtracts the gravity components produced by the dynamic tilt from the accelerometer output data using equations that are analogous to equation (3) above.

B. Exemplary Optical Motion Sensing System Embodiments

FIG. 6 shows an embodiment 110 of the optical motion sensing system 14 that includes an optical focusing system 112 and an image sensor 114. The optical focusing system 112 may include one or more optical elements that focus light from the object surface 46 onto the active area (or capture plane) of the image sensor 114. The image sensor 114 may be any form of imaging device that is capable of capturing one-dimensional or two-dimensional images of the object surface 46. Exemplary image sensing devices include one-dimensional and two-dimensional CMOS (Complimentary Metal-Oxide Semiconductor) image sensors, and CCD (Charge-Coupled Device) image sensors. The image sensor 114 captures images 116 at a rate (e.g., 1500 pictures or frames per second) that is fast enough so that sequential pictures of the object surface 46 overlap.

In this embodiment, the captured images 116 are processed by an image-based movement detection module 118. In the illustrated embodiment, the image-based movement detection module 118 is part of the processing system 16. In other embodiments, the image-based movement detection module 118 is a separate component of the input apparatus. The image-based movement detection module 118 is not limited to any particular hardware or software configuration, but rather it may be implemented in any computing or processing environment, including in digital electronic circuitry or in computer hardware, firmware, or software. In one implementation, the image-based movement detection module 118 includes a digital signal processor (DSP).

In operation, the image-based movement detection module 118 detects relative movement between the input apparatus and the object surface 46 based on comparisons between images 116 of the surface 46 that are captured by the image sensor 114. In particular, the image-based movement detection module 118 identifies texture or other features in the images and tracks the motion of such features across multiple images. These features may be, for example, inherent to the object surface 46, relief patterns embossed on the object surface 46, or marking patterns printed on the object surface 46. The image-based movement detection module 118 identifies common features in sequential images and outputs movement measures corresponding to the direction and distance by which the identified common features are shifted or displaced.

In some implementations, the image-based movement detection module 118 correlates features identified in successive ones of the images 116 to provide information relating to the position of the object surface 46 relative to the image sensor 114. In general, any type of correlation method may be used to track the positions of features across successive ones of the images 116. In some embodiments, a sum of squared differences correlation method is used to find the locations of identical features in successive images 116 in order to determine the displacements of the features across the images 116. In some of these embodiments, the displacements are summed or integrated over a number of images. The resulting integration values may be scaled to compensate for any image scaling by the optics associated with the image sensor 114. The image-based movement detection module 118 translates the displacement information into two-dimensional relative motion vectors (e.g., X and Y motion vectors) that describe the relative movement of the input device 50 across the surface 56. The processing system 16 produces the control signals 18 from the two-dimensional motion vectors.

Additional details relating to the image processing and correlating methods that are performed by the movement detector 66 can be found in U.S. Pat. Nos. 5,578,813, 5,644,139, 5,703,353, 5,729,008, 5,769,384, 5,825,044, 5,900,625, 6,005,681, 6,037,643, 6,049,338, 6,249,360, 6,259,826, 6,233,368, and 6,927,758. In some embodiments, the optical sensing system and the image-based movement detection module 118 are implemented by an optical mouse navigation sensor module (e.g., an optical mouse navigation sensor available from Avago Technologies, Inc. of San Jose, Calif., U.S.A.).

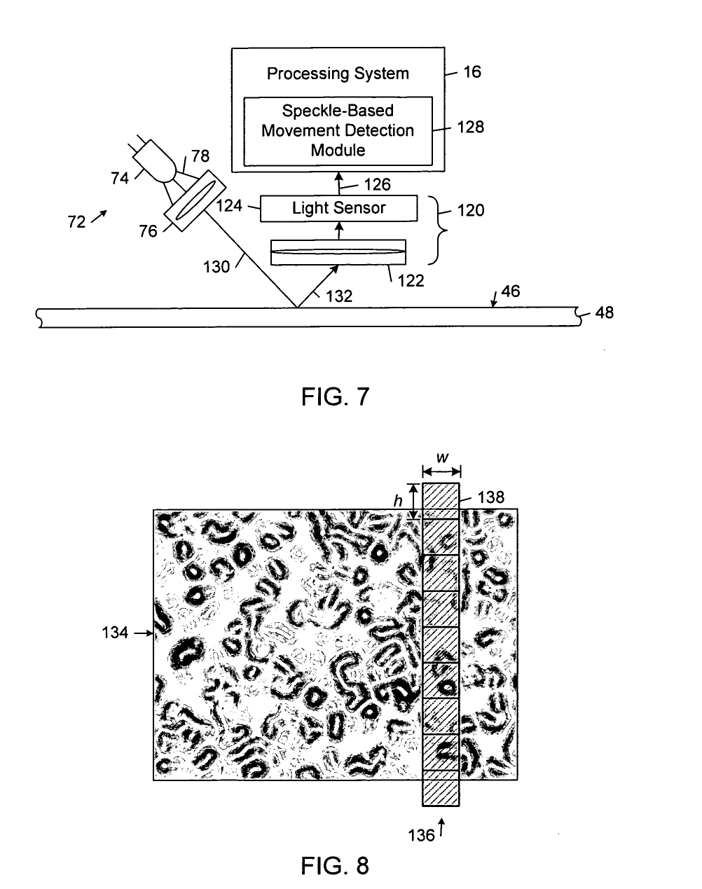

FIG. 7 shows an embodiment 120 of the optical motion sensing system 14 that includes an optical focusing system 122 and a light sensor 124. The optical focusing system 122 may include one or more optical elements that focus light from the object surface 46 onto the active area (or capture plane) of the image sensor 124. The light sensor may be any form of light sensing device that includes at least one photosensor element. Exemplary light sensing devices include photodiodes, one-dimensional and two-dimensional CMOS image sensors, and CCD image sensors.

The light sensor 124 generates light sensor output 126 in response to light from the illumination system 72 that reflects off the object surface 46. In these embodiments, the light source 74 is a source (e.g., a laser) of a substantially coherent light beam 130. In application environments in which the object 48 has a very smooth surface 46 (e.g., a glass surface), the reflected portion 132 of the coherent light beam 130 will exhibit a speckle pattern, which is a pattern of light intensity that is caused by the mutual interference of partially coherent portions of the coherent beam 130 that experience very small temporal and spatial fluctuations in the course of being reflected by the object surface 46. FIG. 8 shows an example of a speckle pattern 134 in which only the edges of the speckle are shown.

In general, the light sensor 124 should produce an output 126 that varies in response to relative movement between the light sensor 124 and the speckle pattern 134. FIG. 8 also shows an exemplary embodiment 136 of the light sensor 124 that includes a linear array of photosensor elements 138 (pixels). In this embodiment, each of the photosensor elements 138 has a width dimension w and a height dimension h that are approximately the same in size as the speckle dimensions (e.g., on the order of 1-10 micrometers). In this way, the output of each photosensor element 138 will vary as the speckle pattern moves in relation to the light sensor 136. In another exemplary embodiment, the light sensor 124 is implemented by a single photosensor element that has an elongated photosensing area that is approximately the same size as the aggregate area of the photosensor elements 138 in the light sensor 136. In still other exemplary embodiments, the light sensor 124 is implemented by a two-dimensional array of the photosensor elements 138.

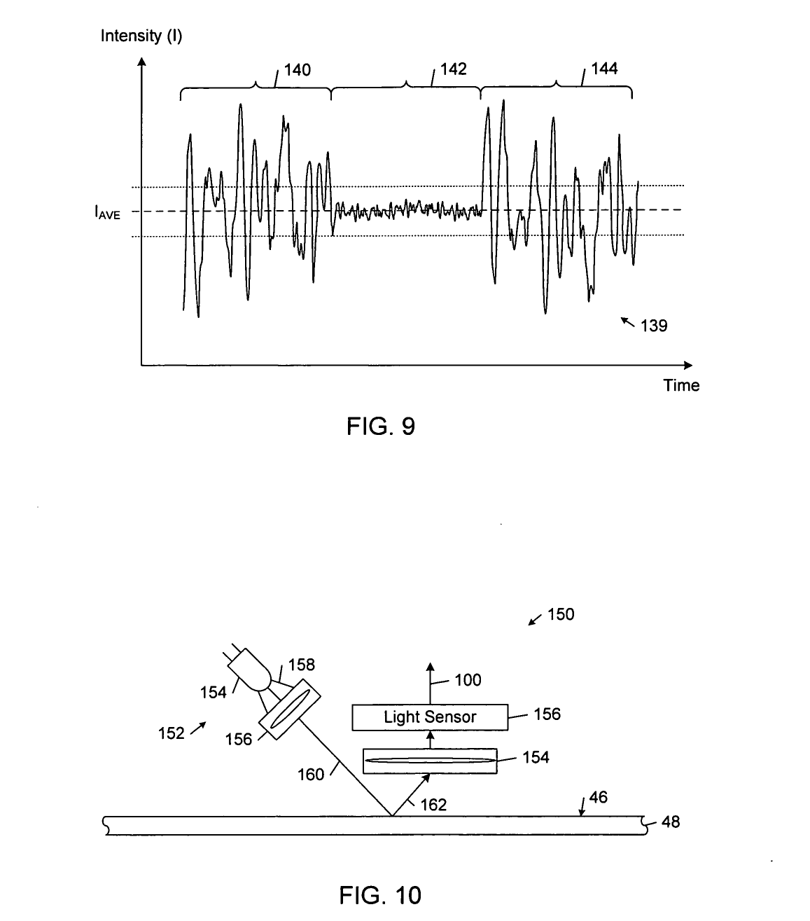

FIG. 9 shows a devised graph 139 of light intensity determined from the output 126 of the light sensor 124 plotted as a function of time. In this graph 139, the determined intensity (I) corresponds to a combination (e.g., a sum) of the intensity of light measured across an elongated active area of the light sensor 124. For example, with respect to the light sensor 136, the determined intensity (I) corresponds to the sum of the outputs of all the photosensing elements 138. With respect to the embodiment in which the light sensor 124 is implemented by a single photosensor element, the determined intensity (I) corresponds to the output of the single photosensor element. With respect to embodiments in which the light sensor 124 is implemented by a two-dimensional array of photosensor elements, the determined intensity (I) corresponds to the sum of the outputs of the photosensor elements in a selected row or column of the two-dimensional array.

In FIG. 9, the periods 140, 142 correspond to times during which the light sensor 124 is moving in relation to the object surface 46, whereas the period 144 corresponds to times during which the light sensor 124 is not moving in relation to the object surface 46. As shown in the devised graph 139, the variations in the determined intensity (I) are greater during the in-motion periods 140, 142 than they are during the motionless period 144 when the determined intensity variations are assumed to be caused primarily by various types of noise.

The light sensor output 126 is processed by a speckle-based movement detection module 128. In the illustrated embodiment, the speckle-based movement detection module 128 is part of the processing system 16. In other embodiments, the speckle-based movement detection module 128 is a separate and discrete component of the input apparatus. The speckle-based movement detection module 128 is not limited to any particular hardware or software configuration, but rather it may be implemented in any computing or processing environment, including in digital electronic circuitry or in computer hardware, firmware, or software. In one implementation, the speckle-based movement detection module 128 includes a digital signal processor (DSP).

In some embodiments, the speckle-based movement detection module 128 distinguishes the in-motion periods 140, 142 from the motionless period 144 based on comparisons of the determined intensity (I) with measures of the average intensity (IAVE) In this process, the speckle-based movement detection module 128 determines average intensity measures from sets of ones of the successive intensity measures (I). In some implementations, the speckle-based movement detection module 128 determines the average intensity measures from the determined intensities within a moving window that has an empirically determined duration. The speckle-based movement detection module 128 thresholds the deviation of the determined intensities (I) from the average intensity measures to determine whether the input apparatus (or a movable input portion of the input apparatus) is in-motion or is motionless.

In some embodiments, the speckle-based movement detection module 128 selects one of the in-motion output state and the motionless output state based on a thresholding of a ratio between a current one of the intensity measures (I(t)) and a respective one of the average intensity measures (IAVE). For example, in some of these embodiments, the speckle-based movement detection module 128 selects the output state based on the following motion detection predicate:

$$\begin{matrix} If \frac{I ( t )}{{I}_{AVE}} \geq α , & select in \text{-} motion output state \\ otherwise , & select motionless output state\end{matrix} \qquad ( 4 )$$

where α is an empirically determined threshold value.

In other embodiments, the speckle-based movement detection module 128 selects one of the in-motion output state and the motionless output state based on a thresholding of a difference between a respective one of the intensity measures and a respective one of the average intensity measures. For example, in some of these embodiments, the speckle-based movement detection module 128 selects the output state based on the following motion detection predicate:

If |I(t)−I_{AVE}|>K, select in-motion output state (5)
otherwise, select motionless output state
   where K is an empirically determined threshold value.

In some embodiments, the speckle-based movement detection module 128 may apply one or more morphological operations (e.g., a smoothing filter or a closing filter) to the determined intensity (I) before making the determination of whether the input apparatus (or a movable input portion of the input apparatus) is in-motion or is motionless.

C. Exemplary Optical Lift Detection System Embodiments

FIG. 10 shows an embodiment 150 of the optical lift detection system 98 shown in FIG. 5. The optical lift detection system 150 includes an illumination system 152, an optical focusing system 154, and a light sensor 156.

In the illustrated embodiment, the illumination system 152 is implemented by a light source 154 (e.g., a light emitting diode or a laser) and an optical element 156 that collimates the light 158 that is produced by the light source 152 into a collimated output light beam 160. The illumination system 152 is oriented to direct the output light beam 160 toward the object 48 to produce the reflected beam 162.

The optical focusing system 156 includes one or more optical elements (e.g., refractive lenses, diffractive lenses, and optical filters) that focus light from a relatively short distance (e.g., 0.1 millimeter to 10 millimeters) away from the bottom surface of the housing onto an active area (or capture plane) of the light sensor 156.

The light sensor 156 may be any form of light sensing device that includes at least one photosensor element. Exemplary light sensing devices include photodiodes, one-dimensional and two-dimensional CMOS image sensors, and CCD image sensors.

Due to the arrangement of the illumination system 152 and the relatively short front focal distance of the optical focusing system 156, the reflected light beam 162 will only reach the active area of the light sensor 156 when the object surface 46 is adjacent to the optical focusing system 156. Consequently, the light intensity measured by the lift detection output 100 will be relatively high when the object surface 46 is adjacent the optical focusing system 156 and will be relatively low when the object surface 46 is remote from the optical focusing system 156. In some embodiments, the processing system 16 determines whether the input apparatus is on the object surface 46 or has been lifted off the object surface 46 by thresholding the lift detection output 100.

### V. Conclusion

The embodiments that are described in detail herein provide input apparatus that are capable of generating control signals (e.g., user interface control signals) in response to movements in relation to a fixed inertial reference frame (e.g., a reference frame defined by the direction of gravitational acceleration). These embodiments are capable of generating control signals independently of the surfaces over which the input apparatus might be moved and, therefore, these embodiments avoid the limitations of optical navigation sensors with respect to navigating over smooth surfaces and surfaces that are substantially transparent to the illuminating light. In addition, these embodiments overcome problems that typically result from the noise that is inherent in inertia-based navigation systems.

Other embodiments are within the scope of the claims.

What is claimed is:

1. An apparatus, comprising:
an inertia sensing system operable to generate inertial data indicative of movement in relation to an inertial reference frame;
an optical motion sensing system operable to generate optical data from received light; and
a processing system operable to determine movement measures from the inertial data and to select one of an in-motion output state and a motionless output state based on the optical data, wherein, during the in-motion output state, the processing system produces an output corresponding to the movement measures and, during the motionless output state, the processing system produces an output indicative of zero motion regardless of the inertial data.

2. The apparatus of claim 1, wherein the inertial sensing system comprises at least one accelerometer operable to produce a respective accelerator output, and the processing system is operable to determine at least some of the motion measures from the accelerator output.

3. The apparatus of claim 2, wherein the processing system is operable to determine from the accelerator output measures of static tilt in relation to the inertial reference frame, and the processing system is operable to determine at least some of the motion measures from the accelerometer output and the measures of static tilt.

4. The apparatus of claim 2, wherein the inertia sensing system comprises at least one angular rate sensor operable to produce a respective angular rate sensor output.

5. The apparatus of claim 4, wherein the processing system is operable to determine measures of dynamic tilt from the angular rate sensor output and the processing system is operable to determine at least some of the motion measures from the accelerometer output and the measures of dynamic tilt.

6. The apparatus of claim 1, further comprising a housing containing the inertia sensing system and the optical motion sensing system, and comprising a bottom side configured to slide over a surface of an object.

7. The apparatus of claim 6, wherein the optical motion sensing system generates the optical data in response to light received from the bottom side of the housing.

8. The apparatus of claim 7, further comprising an illumination system in the housing and operable to direct a light beam out from the bottom side of the housing, wherein the optical motion sensing system is operable to generate the optical data from at least a portion of the light beam reflecting off the object s surface when the bottom side of the housing is adjacent the object surface.

9. The apparatus of claim 8, wherein the optical motion sensing system comprises a light sensor and an optical focusing system operable to focus at least a portion of the light beam reflecting off the object surface onto the light sensor when the bottom side of the housing is adjacent the object surface.

10. The apparatus of claim 6, wherein the housing additionally comprises an optical input side different from the bottom side, and the optical motion sensing system is operable to generate the optical data in response to the light received from the optical input side of the housing.

11. The apparatus of claim 10, wherein the optical motion sensing system comprises a light sensor and an optical focusing system operable to focus light from a remote distance onto the light sensor.

12. The apparatus of claim 10, further comprising an optical lift detection system operable to generate a lift detection output from light reflecting off the object surface, wherein the processing system is operable to select one of the in-motion output state and the motionless output state from the lift detection output.

13. The apparatus of claim 1, wherein the optical motion sensing system is operable to capture images of the received light, and the processing system is operable to select one of the in-motion output state and the motionless output state based on differences between the of ones of the captured images.

14. The apparatus of claim 13, wherein the processing system selects the motionless output state in response to a determination that differences between ones of the captured images fail to meet at least one difference threshold, and the processing system selects the in-motion output state in response to a determination that the differences between ones of the captured images meet the at least one difference threshold.

15. The apparatus of claim 1, wherein the processing system is operable to: determine successive intensity measures from the optical data generated over time, determine average intensity measures from sets of ones of the successive intensity measures; and select one of the in-motion output state and the motionless output state based on a comparison of a respective one of the intensity measures to a respective one of the average intensity measures.

16. The apparatus of claim 15, wherein the processing system selects one of the in-motion output state and the motionless output state based on a thresholding of a ratio between a respective one of the intensity measures and a respective one of the average intensity measures.

17. The apparatus of claim 15, wherein the processing system selects one of the in-motion output state and the motionless output state based on a thresholding of a difference between a respective one of the intensity measures and a respective one of the average intensity measures.

18. An apparatus, comprising:
inertia sensing means operable to generate inertial data indicative of movement in relation to an inertial reference frame;
optical motion sensing means operable to generate optical data from received light; and
processing means operable to determine movement measures from the inertial data and to select one of an in-motion output state and a motionless output state based on the optical data, wherein, during the in-motion output state, the processing system produces an output corresponding to the movement measures and, during the motionless output state, the processing system produces an output indicative of zero motion regardless of the inertial data.

19. A method, comprising:
generating inertial data indicative of movement in relation to an inertial reference frame;
generating optical data from received light;
determining movement measures from the inertial data;
selecting one of an in-motion output state and a motionless output state based on the optical data;
during the in-motion output state, producing an output corresponding to the movement measures; and
during the motionless output state, producing an output indicative of zero motion regardless of the inertial data.

20. The method of claim 19, further comprising determining measures of static tilt in relation to the inertial reference frame during the motionless output state, wherein the determining of the movement measures comprises determining at least some of the motion measures based on the measures of static tilt.

21. The apparatus of claim 19, further comprising determining measures of dynamic tilt, wherein the determining of the movement measures comprises determining at least some of the motion measures based on the measures of dynamic tilt.

22. The method of claim 19, wherein the generating of optical data comprises capturing images of the received light, and the selecting comprises selecting one of the in-motion output state and the motionless output state based on differences between the of ones of the captured images.

23. The method of claim 19, further comprising determining successive intensity measures from the optical data generated over time, and determining average intensity measures from sets of ones of the successive intensity measures,
wherein the selecting comprises selecting one of the in-motion output state and the motionless output state based on a comparison of a respective one of the intensity measures to a respective one of the average intensity measures.
